(19) United States
(12) Patent Application Publication
(10) Pub. No.: US 2025/0171635 A1
(43) Pub. Date: May 29, 2025

(54) CURABLE SILICONE COMPOSITION

(71) Applicant: DOW SILICONES CORPORATION, Midland, MI (US)

(72) Inventor: Juyoung YOOK, Chungcheongbuk-Do (KR)

(21) Appl. No.: 18/840,627

(22) PCT Filed: Feb. 23, 2023
(86) PCT No.: PCT/US2023/013660

§ 371 Date: Aug. 22, 2024

Related U.S. Application Data
(60) Provisional application No. 63/313,396, filed on Feb. 24, 2022.

(51) Int. Cl. C08L 83/04; C08G 77/00; C08G 77/08; C08G 77/16; C08K 3/36

(52) U.S. Cl. CPC C08L 83/04; C08G 77/08; C08G 77/16; C08G 77/70; C08G 77/80; C08K 3/36; C08K 2201/006; C08L 2201/10; C08L 2205/025

(57) ABSTRACT

This disclosure relates to a curable silicone composition comprising: (A) an organopolysiloxane resin having an alkenyl group in a molecule; (B) an organosiloxane oligomer having a viscosity at 25° C. of not more than 1,000 mPa·s, having at least one silicon atom-bonded alkenyl group or silicon atom-bonded hydrogen atom, and having at least one silicon atom-bonded aryl group in a molecule; (C) an organopolysiloxane having at least one alkenyl group and not having a silicon atom-bonded aryl group and SiO_{4/2} unit in a molecule, or an organopolysiloxane having at least one silicon atom-bonded hydrogen atom and not having a silicon atom-bonded aryl group in a molecule; (D) a silica filler; and (E) a hydrosilylation reaction catalyst. The composition has an excellent thixotropic property and can cure to form a transparent cured product despite containing a large quantity of an organopolysiloxane resin.

### CROSS-REFERENCE TO RELATED APPLICATIONS

This application claims priority to and all advantages of U.S. Provisional Patent Application No. 63/313,396 filed on 24 Feb. 2022, the content of which is incorporated herein by reference

### TECHNICAL FIELD

The present invention relates to a curable silicone composition.

### BACKGROUND ART

Curable silicone compositions comprising: an organopolysiloxane resin consisting of (CH₃)₃SiO_{1/2} units, CH₂═CH(CH₃)SiO_{2/2} units and SiO_{4/2} units, an organopolysiloxane having at least two silicon atom-bonded hydrogen atoms in a molecule, and a hydrosilylation reaction catalyst, cure to form transparent cured products having excellent heat resistance, electrical insulating properties and weatherability. Therefore, the curable silicone compositions are widely used as protective coating agents, encapsulants or sealants of electric/electronic equipment. In a specific application, a thixotropic property of the curable silicone composition is needed to control flowability and to make its shape kept after dispensing it.

For example, Patent Document 1 discloses in Example 1 a curable silicone composition comprising: an organopolysiloxane resin consisting of CH₂═CH(CH₃)₂SiO_{1/2} units, (CH₃)₃SiO_{1/2} units and SiO_{4/2} units, a vinyl group-terminated dimethylpolysiloxane, a methylhydrogenpolysiloxane, and a platinum catalyst. Patent Document 1 also discloses, insofar as transparency is not impaired, inorganic fillers such as fumed silica for enhancing strength. However, Patent Document 1 is silent about enhancing a thixotropic property of the curable silicone composition.

Patent Document 2 discloses in Example 4 a curable silicone composition comprising: a copolymer of dimethylsiloxane and methylvinylsiloxane capped at both molecular chain terminals with dimethylvinylsiloxy groups, an organopolysiloxane resin consisting of CH₂═CH(CH₃)₂SiO_{1/2} units, (CH₃)₃SiO_{1/2} units and SiO_{4/2} units, a methylhydrogenpolysiloxane consisting of (CH₃)₂HSiO_{1/2} units and SiO_{4/2} units, a platinum catalyst, and fumed silica. However, the curable silicone composition cured to form a poor transparent cured product. Patent Document 2 also discloses in Example 5 a curable silicone composition comprising: a copolymer of dimethylsiloxane and diphenylsiloxane capped at both molecular chain terminals with dimethylvinylsiloxy groups, an organopolysiloxane resin consisting of CH₂═CH(CH₃)₂SiO_{1/2} units, (CH₃)₃SiO_{1/2} units and SiO_{4/2} units, a methylhydrogenpolysiloxane consisting of (CH₃)₂HSiO_{1/2} units and SiO_{4/2} units, and a platinum catalyst. However, Patent Document 2 is silent about enhancing a thixotropic property of the curable silicone composition.

Patent Document 3 discloses in Example 1 a curable silicone composition comprising: a copolymer of dimethylsiloxane and diphenylsiloxane capped at both molecular chain terminals with trivinylsiloxy groups, an organopolysiloxane resin consisting of CH₂═CH(CH₃)₂SiO_{1/2} units, (CH₃)₃SiO_{1/2} units and SiO_{4/2} units, a polymethylhydrogensiloxane consisting of (CH₃)₂HSiO_{1/2} units and SiO_{4/2} units, a methylhydrogenpolysiloxane capped at both molecular chain terminals with trimethylsiloxy groups, a platinum catalyst, fumed silica, and an organopolysiloxane having glycidoxypropyl groups as a thixotropy imparting agent. The curable silicone composition cures to form a transparent cured product, but a thixotropic property thereof is poor in comparison with the composition used a dimethylpolysiloxane capped at both molecular chain terminals with dimethylvinylsiloxy groups instead of the copolymer of dimethylsiloxane and diphenylsiloxane.

Patent Document 4 discloses in Examples curable silicone compositions comprising: a copolymer of dimethylsiloxane and diphenylsiloxane capped at both molecular chain terminals with dimethylvinylsiloxy groups, an organopolysiloxane resin consisting of (CH₃)₃SiO_{1/2} units, CH₂═CH(CH₃)SiO_{2/2} units and SiO_{4/2} units, an organohydrogenpolysiloxane consisting of (CH₃)₂HSiO_{1/2} units and SiO_{4/2} units, or a copolymer of methylhydrogensiloxane and dimethylsiloxane capped at both molecular chain terminals with trimethylsiloxy groups, a platinum catalyst, and fumed silica. These curable silicone compositions have a thixotropic property and cure to form a transparent cured product. However, the organopolysiloxane resin needs to contain R2SiO_{2/2} units, wherein each R independently represents an alkenyl group, or an alkyl group which may be halogen-substituted. Furthermore, an amount of the organopolysiloxane resin is limited to in a range of from 10 to 40 mass % based on a total of the linear organopolysiloxane and the organopolysiloxane resin.

### PRIOR ART DOCUMENTS

### Patent Documents

Patent Document 1: U.S. Patent Application Publication No. 2004/0116640 A1

Patent Document 2: Japanese Patent Application Publication No. 2006-335857 A

Patent Document 3: Korean Patent Application Publication No. 10-2009-0103785 A

Patent Document 4: Korean Patent Application Publication No. 10-2015-0065672 A

### BRIEF SUMMARY OF INVENTION

### Technical Problem

An object of the present invention is to provide a curable silicone composition which has an excellent thixotropic property and can cure to form a transparent cured product despite containing a large quantity of an organopolysiloxane resin.

### Solution to Problem

The curable silicone composition of the present invention comprises:
(A) an organopolysiloxane resin represented by the following average unit formula:

(R¹₃SiO_{1/2})ₐ(R²R¹₂SiO_{1/2})_{b}(SiO_{4/2})_{c}(HO_{1/2})_{d}
wherein each R¹ is independently an alkyl group; R² is an alkenyl group; and “a”, “b”, “c” and “d” are numbers satisfying the following conditions: a≥0, b>0, 0.3≤c≤0.7, 0≤d≤0.05, and a+b+c=1;
(B) an organosiloxane oligomer having a viscosity at 25° C. of not more than 1,000 mPa·s, and selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);
(C) an organopolysiloxane selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, and a mixture of components (C₁) and (C₂);
(D) a silica filler; and
(E) a catalytic amount of a hydrosilylation reaction catalyst;
wherein an amount of component (A) is in a range of from 40.0 to 65.0 mass %, an amount of component (B) is in a range of from 1.0 to 55.0 mass %, and an amount of component (C) is in a range of from 0 to 50.0 mass %, each based on a total mass of components (A) to (C), and an amount of component (D) is in a range of from 1 to 10 parts by mass relative to 100 parts by mass of a total mass of components (A) to (C), with the proviso that a molar ratio of all silicon atom-bonded hydrogen atoms relative to all silicon atom-bonded alkenyl groups in components (A) to (C) is in a range of from 0.5 to 2.0.

In various embodiments, component (B₁) is at least one selected from (B₁₁) an organosiloxane oligomer represented by the following general formula:

R²R³₂SiO(R³₂SiO)ₘSiR³₂R²
wherein each R² is independently an alkenyl group; each R³ is independently an alkyl group or an aryl group, with the proviso that at least one R³ is an aryl group; and “m” is an integer of 0 to 10, and
(B₁₂) an organosiloxane oligomer represented by the following average unit formula:

(R²R³₂SiO_{1/2})ₑ(R³SiO_{3/2})_{f}
wherein R² and R³ are as described above; and “e” and “f” are numbers satisfying the following conditions: e>0, f>0, and e+f=1.

In various embodiments, component (B₁₁) is at least one selected from organosiloxane oligomers represented by the following formulae:

(CH₂═CH)(CH₃)₂SiO(C₆H₅)₂SiOSi(CH₃)₂(CH═CH₂)

(CH₂═CH)(CH₃)₂SiO(C₆H₅)(CH₃)SiOSi(CH₃)₂(CH═CH₂)

(CH₂═CH)(CH₃)(C₆H₅)SiOSi(CH₃)(C₆H₅)(CH═CH₂)
and component (B₁₂) is an organosiloxane oligomer represented by the following general unit formula:

[(CH₂═CH)(CH₃)₂SiO_{1/2}]ₑ[(C₆H₅)SiO_{3/2}]_{f}
wherein “e” and “f” are as described above.

In various embodiments, component (B₂) is at least one selected from (B₂₁) an organosiloxane oligomer represented by the following general formula:

HR³₂SiO(R³₂SiO)ₘSiR³₂H
wherein each R³ is independently an alkyl group or an aryl group, with the proviso that at least one R³ is an aryl group; and “m” is an integer of 0 to 10, and (B₂₂) an organosiloxane oligomer represented by the following average unit formula:

(R³₂HSiO_{1/2})ₑ(R³SiO_{3/2})_{f}
wherein R³ is as described above; and “e” and “f” are numbers satisfying the following conditions: e>0, f>0, and e+f=1.

In various embodiment, component (B₂₁) is at least one selected from organosiloxane oligomers represented by the following formulae:

H(CH₃)₂SiO(C₆H₅)₂SiOSi(CH₃)₂H

H(CH₃)₂SiO(C₆H₅) (CH₃)SiOSi(CH₃)₂H
and component (B₂₂) is an organosiloxane oligomer represented by the following general unit formula:

[(CH₃)₂HSiO_{1/2}]ₑ[(C₆H₅)SiO_{3/2}]_{f}
wherein “e” and “f” are as described above.

In various embodiments, the curable silicone composition further comprises: (F) a hydrosilylation reaction inhibitor, in an amount of 0.1 to 10,000 ppm in this component in terms of mass units with respect to the composition.

In various embodiments, the curable silicone composition further comprises: (G) an adhesion promotor, in an amount of at most 10 parts by mass relative to 100 parts by mass of a total mass of components (A) to (C).

### Effects of Invention

The curable silicone composition of the present invention has an excellent thixotropic property and can cure to form a transparent cured product despite containing a large quantity of an organopolysiloxane resin.

### Definitions

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims.

Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### DETAILED DESCRIPTION OF THE INVENTION

The curable silicone composition of the present invention will be explained in detail.

Component (A) is an organopolysiloxane resin represented by the following average unit formula:

(R¹₃SiO_{1/2})ₐ(R²R¹₂SiO_{1/2})_{b}(SiO_{4/2})_{c}(HO_{1/2})_{d}.

In the formula, each R¹ is independently an alkyl group. The alkyl groups are exemplified by alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups. Among these, methyl groups are preferable.

In the formula, R² is an alkenyl group. The alkenyl groups are exemplified by alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. Among these, vinyl groups are preferable.

In the formula, “a”, “b”, “c” and “d” are numbers satisfying the following conditions: a>0, b>0, 0.3≤c≤0.7, 0≤d≤0.05, and a+b+c=1, optionally 0.1≤a≤0.5, 0.01≤b≤0.2, 0.4≤c≤0.7, 0≤d≤0.05, and a+b+c=1, or optionally 0.2≤a≤0.5, 0.01≤b≤0.2, 0.4≤c≤0.7, 0≤d≤0.05, and a+b+c=1. This is because, if “a”, “b”, “c” and “d” are numbers within the ranges mentioned above, a cured product obtained by curing the present composition will have appropriate hardness and mechanical strength.

A molecular weight of the organopolysiloxane resin for component (A) is not limited, however, its number average molecular weight (Mn) measured in terms of standard polystyrene by gel permeation chromatography (GPC) is preferably at least 1,500 g/mol, alternatively at least 2,000 g/mol, or alternatively at least 3,000 g/mol; while at the same time the Mn is preferably not more than 6,000 g/mol; alternatively not more than 5,500 g/mol. The Mn of component (A) can be an arbitrary range that combines the upper and lower limits described above. Note that if component (A) is in a solid state at 25° C. and it is difficult to uniformly mix other components in the present composition, such can be resolved by preparing an organic solution of component (A) in advance, and mixing with a portion or all of components (B) and (C), after which the used organic solvent can be removed from this mixture. Note that the organic solvent which can be used to prepare the organic solution of component (A) can be used as long as it can dissolve component (A) and be easily removed. While not limited thereto, specific examples thereof include: aromatic hydrocarbons such as toluene and xylene; and aliphatic hydrocarbons such as hexane and heptane.

Component (A) is used in an amount of from 40.0 to 65.0 mass %, alternatively in an amount of from 40.0 to 62.0 mass %, alternatively in an amount of from 45.0 to 65.0 mass %, or alternatively in an amount of from 45.0 to 62.0 mass %, each based on a total mass of components (A) to (C). This is because, if the amount is equal to or above the lower limit of the ranges described above, a cured product obtained by curing the present composition will have appropriate hardness and mechanical strength, whereas the amount is equal to or below the upper limit of the ranges described above, the composition has suitable viscosity at 25° C.

Component (B) is an organosiloxane oligomer to impart the curable silicone composition with a thixotropic property, and to impart a cured product obtained by curing the composition with transparency. A molecular structure of the organosiloxane oligomer for component (B) is not limited, however, are exemplified by straight chain, partially branched straight chain, and branched chain. A molecular weight of the organosiloxane oligomer for component (B) is not limited, however, it is preferably not more than 2,000 g/mol, alternatively not more than 1,500 g/mol. Such the organosiloxane oligomer typically has a viscosity at 25 ° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

The organosiloxane oligomer for component (B) also act as a chain extending agent or a crosslinking agent for the composition, and is selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂).

The organosiloxane oligomer for component (B₁) is typically at least one selected

from (B₁₁) an organosiloxane oligomer represented by the following general formula:

R²R³₂SiO(R³₂SiO) mSiR³₂R²
and (B₁₂) an organosiloxane oligomer represented by the following average unit formula:

(R²R³₂SiO_{1/2})ₑ(R³SiO_{3/2})
Among these, component (B₁₁) is preferable.

In the formulae, each R² is independently an alkenyl group, and examples thereof include the same groups as those described above. Among these, vinyl groups are preferable.

In the formulae, each R³ is independently an alkyl group or an aryl group. Examples of alkyl groups for R³ include the same alkyl groups as R¹ described above. Examples of aryl groups for R³ include aryl groups with 6 to 12 carbon atoms such as phenyl groups, tolyl groups, xylyl groups and naphthyl groups. However, at least one R³ is an aryl group, typically a phenyl group.

In the formula, “m” is an integer of 0 to 10, alternatively an integer of 0 to 5, alternatively an integer of 0 to 3, or alternatively an integer of 0 or 1.

In the formula, “e” and “f” are numbers satisfying the following conditions: e>0, f>0, and e+f=1, alternatively 0.3<e and e+f=1, or alternatively 0.5<e and e+f=1.

Component (B₁) is typically at least one selected from organosiloxane oligomers represented by the following formulae:

(CH₂═CH)(CH₃)₂SiO(C₆H₅)₂SiOSi(CH₃)₂(CH═CH₂)

(CH₂═CH)(CH₃)₂SiO(C₆H₅) (CH₃)SiOSi(CH₃)₂(CH═CH₂)

(CH₂═CH)(CH₃)(C₆H₅)SiOSi(CH₃)(C₆H₅)₂(CH═CH₂)
and component (B₁₂) is typically an organosiloxane oligomer represented by the following general unit formula:

[(CH₂═CH)(CH₃)₂SiO_{1/2}]ₑ[(C₆H₅)SiO_{3/2}]_{f}
wherein “e” and “f” are as described above.

The organosiloxane oligomer for component (B₂) is typically at least one selected from (B₂₁) an organosiloxane oligomer represented by the following general formula:

HR³₂SiO(R³₂SiO)ₘSiR³₂H
and (B₂₂) an organosiloxane oligomer represented by the following average unit formula:

(R³₂HSiO_{1/2})ₑ(R³SiO_{3/2})
Among these, component (B₂₁) is preferable.

In the formulae, each R³ is an alkyl group or an aryl group, and examples thereof include the same groups as those described above. However, at least one R³ is an aryl group, typically a phenyl group.

In the formula, “m” is an integer of 0 to 10, alternatively an integer of 0 to 5, alternatively an integer of 0 to 3, or alternatively an integer of 0 or 1.

In the formula, “e” and “f” are numbers satisfying the following conditions: e>0, f>0, and e+f=1, alternatively 0.3<e and e+f=1, or alternatively 0.5<e and e+f=1.

Component (B₂₁) is typically at least one selected from organosiloxane oligomers

represented by the following formulae:

H(CH₃)₂SiO(C₆H₅)₂SiOSi(CH₃)₂H

H(CH₃)₂SiO(C₆H₅)(CH₃)SiOSi(CH₃)₂H
and component (B₂₂) is typically an organosiloxane oligomer represented by the following general unit formula:

[(CH₃)₂HSiO_{1/2}]ₑ[(C₆H₅)SiO_{3/2}]_{f}

wherein “e” and “f” are as described above.

Component (B) is used in an amount of from 1.0 to 55.0 mass %, alternatively in an amount of from 1.0 to 50.0 mass %, or alternatively in an amount of from 1.0 to 45.0 mass %, each based on a total mass of components (A) to (C). This is because, if the amount is equal to or above the lower limit of the ranges described above, the composition has good thixotropic property, whereas the amount is equal to or below the upper limit of the ranges described above, the obtained cured product has good transparency. The organosiloxane oligomer for component (B) may be a mixture of components (B₁) and (B₂). However, the amounts of components (B₁) and (B₂) are not limited, but the amount of component (B) should be an amount that a molar ratio of all silicon atom-bonded hydrogen atoms relative to all silicon atom-bonded alkenyl groups in components (A) to (C) is in a range of from 0.5 to 2.0.

Component (C) is an arbitrary component and an organopolysiloxane selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, and a mixture of components (C₁) and (C₂).

If a mixture of components (A) and (B) can be cured fully, an addition of component (C) is optional. However, if the mixture cannot be cured for lack of silicon atom-bonded alkenyl groups, component (C₁) should be added, whereas, if the mixture cannot be cured for lack of silicon atom-bonded hydrogen atoms, component (C₂) should be added. Furthermore, if the cured product obtained by curing the present composition is hard, component (C) as a chain extending agent should be added, whereas, if the cured product obtained by curing the present composition is soft, component (C) as a crosslinking agent should be added.

Component (C₁) is an organopolysiloxane having at least one alkenyl group and not having a silicon atom-bonded aryl group and SiO_{4/2} unit in a molecule. Examples of the alkenyl groups include alkenyl groups with 2 to 12 carbon atoms such as vinyl groups, allyl groups, butenyl groups, pentenyl groups, hexenyl groups, heptenyl groups, octenyl groups, nonenyl groups, decenyl groups, undecenyl groups and dodecenyl groups. Among these, vinyl groups are preferable. In addition, examples of groups bonding to silicon atoms other than alkenyl groups in component (C₁) include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₁) is not limited, but is typically a straight-chain structure, a partially branched straight-chain structure, a branched-chain structure, or a cyclic structure. Component (C₁) may be one type of organopolysiloxane having these molecular structures or may be a mixture of two or more types of organopolysiloxanes having these molecular structures.

Examples of such component (C₁) include dimethylpolysiloxanes capped at both molecular chain terminals with dimethylvinylsiloxy groups, copolymers of dimethylsiloxane and methylvinylsiloxane capped at both molecular chain terminals with dimethylvinylsiloxy groups, copolymers of dimethylsiloxane and methylvinylsiloxane capped at both molecular chain terminals with trimethylsiloxy groups, and mixtures of two or more types thereof.

Component (C₂) is an organopolysiloxane having at least one silicon atom-bonded hydrogen atom and not having a silicon atom-bonded aryl group in a molecule. Examples of groups bonding to silicon atoms in component (C₂) include alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups and dodecyl groups.

A molecular structure of component (C₂) is not limited, but is typically a straight-chain structure, a partially branched straight-chain structure, a branched-chain structure, a cyclic structure, or a three-dimensional reticular structure. Component (C₂) may be one type of organopolysiloxane having these molecular structures or may be a mixture of two or more types of organopolysiloxanes having these molecular structures. Examples of such component (C₂) include methylhydrogenpolysiloxanes capped at

both molecular chain terminals with trimethylsiloxy groups, copolymers of dimethylsiloxane and methylhydrogensiloxane capped at both molecular chain terminals with trimethylsiloxy groups, dimethylpolysiloxanes capped at both molecular chain terminals with dimethylhydrogensiloxy groups, copolymers of dimethylsiloxane and methylhydrogensiloxane capped at both molecular chain terminals with dimethylhydrogensiloxy groups, copolymers consisting of (CH₃)₂HSiO_{1/2} units and SiO_{4/2} units, copolymers consisting of (CH₃)₂HSiO_{1/2} units, (CH₃)₃HSiO_{1/2} units, and SiO_{4/2} units, and mixtures of two or more types thereof.

The organopolysiloxane for component (C) may be a mixture of components (C₁) and (C₂). However, component (C) typically has a viscosity at 25° C. of not more than 1,000 mPa·s, alternatively not more than 500 mPa·s, or alternatively not more than 100 mPa·s. Note that in the present specification, viscosity is the value measured using a type B viscometer according to ASTM D 1084 at 23±2° C.

Component (C) is used in an amount of from 0 to 55.0 mass %, alternatively in an amount of from 0.1 to 50.0 mass %, or alternatively in an amount of from 0.5 to 45.0 mass %, each based on a total mass of components (A) to (C). This is because, if the amount is equal to or above the lower limit of the ranges described above, the composition has good thixotropic property, whereas the amount is equal to or below the upper limit of the ranges described above, the composition has good transparency. The organosiloxane oligomer for component (C) may be a mixture of components (C₁) and (C₂). However, the amounts of components (C₁) and (C₂) are not limited, but the amount of component (C) should be an amount that a molar ratio of all silicon atom-bonded hydrogen atoms relative to all silicon atom-bonded alkenyl groups in components (A) to (C) is in a range of from 0.5 to 2.0.

A molar ratio (“SiH/Vi ratio”) of all silicon atom-bonded hydrogen atoms relative to all silicon atom-bonded alkenyl groups in components (A) to (C) is in a range of from 0.5 to 2.0, alternatively in a range of from 0.5 to 1.5, or alternatively in a range of from 0.8 to1.5. This is because, if the molar ration is equal to or above the lower limit of the ranges described above, the composition can be fully cured, and a cured product obtained by curing the present composition will have appropriate hardness and mechanical strength, whereas the molar ratio is equal to or below the upper limit of the ranges described above, the cured product has good thremal stability.

Component (D) is silica filler to impart the curable silicone composition with a thixotropic property. Component (D) is typically fumed or precipitated silica filler having a BET surface area of at least 50 m²/g, alternatively 80 to 400 m²/g, or alternatively 100 to 400 m²/g. A surface of the silica filer may be un-treated or treated with treating agents such as organochlorosilanes, organoalkoxysilanes, organosilazanes, and organosiloxane oligomers. The silica filler for component (D) is commercially available. Examples of the silica

fillers include fumed silica from Degussa Corporation under the tradename AEROSIL™, such as AEROSIL™ R8200, R9200, R812, R812S, R972, R974, R805, R202; fumed silica from Cabot Corporation under the tradename CAB-O-SIL™ ND-TS, TS610 or TS710; and fumed silica from Tokuyama Corporation under the tradename REOLOSIL™, such as DM-10, DM-20S, DM-30, HM-30S, MT-10, PM-20L, QS-10, QS-20A, and QS-25C.

An amount of component (D) is in a range of from 1 to 10 parts by mass, alternatively in a range of from 2 to 10 parts relative to 100 parts by mass of total mass of components (A) to (C). This is because, if the amount of component (D) is equal to or above the lower limit of the ranges described above, the composition has an excellent thixotropic property and cured product obtained by curing the present composition has appropriate hardness and mechanical strength, whereas the amount is equal to or below the upper limit of the ranges described above, the curble silicone composition a has good transparency.

Component (E) is a hydrosilylation reaction catalyst used to facilitate curing of the present composition. Hydrosilylation reaction catalyst for component (E) is well known in the art and commercially available. Suitable hydrosilylation catalysts include, without limitation, a platinum group metal which includes platinum, rhodium, ruthenium, palladium, osmium, or iridium metal or an organometallic compound thereof and a combination of any two or more thereof. Component (E) is typically a platinum-based catalyst so that the curing of the present composition can be dramatically accelerated. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being most typical.

In various embodiments, component (E) is a hydrosilylation reaction catalyst that includes complexes of platinum with low molecular weight organopolysiloxanes that include 1,3-divinyl-1,1,3,3-tetramethyldisiloxane complexes with platinum. These complexes may be microencapsulated in a resin matrix. In specific embodiments, the catalyst includes 1,3-divinyl-1,1,3,3-tetramethyldisiloxane complex with platinum.

Examples of suitable hydrosilylation reaction catalysts for component (E) are described in, for example, U.S. Pat. Nos. 3,159,601; 3,220,972; 3,296,291; 3,419,593; 3,516,946; 3,814,730; 3,989,668; 4,784,879; 5,036,117; and 5,175,325 and EP 0 347 895 B.

Microencapsulated hydrosilylation reaction catalysts and methods of preparing them are exemplified in U.S. Pat. Nos. 4,766,176 and 5,017,654.

An amount of component (E) in the present composition is an effective quantity for facilitating curing of the present composition. Specifically, in order to satisfactorily cure the present composition, the content of component (E) is typically a quantity whereby the content of catalytic metal in component (E) relative to the present composition is from about 0.01 to about 500 ppm, alternatively from about 0.01 to about 100 ppm, alternatively from about 0.01 to about 50 ppm, alternatively from about 0.1 to about 10 ppm, in terms of mass units.

In various embodiments, the curable silicone composition comprises (F) a hydrosilylation reaction inhibitor in order to adjust the cure rate of the curable silicone composition. In certain embodiments, component (F) includes, without limitation, an alkyne alcohol such as 2-methyl-3-butyn-2-ol, 3,5-dimethyl-1-hexyn-3-ol, or 2-phenyl-3-butyn-2-ol, 1-ethynyl-cyclohexan-1-ol; an ene-yne compound such as 3-methyl- 3-penten-1-yne or 3,5-dimethyl-3-hexen-1-yne; or 1,3,5,7-tetramethyl-1,3,5,7-tetravinylcyclotetrasiloxane, 1,3,5,7-tetramethyl-1,3,5,7-tetrahexenylcyclotetrasiloxane, tris[(1,1-dimethyl-2-propynyl)oxy]methylsilane, diallyl maleate or a benzotriazole may be incorporated as an optional component in the present composition.

An amount of component (F) in the present composition is not particularly limited, but if included is typically in an amount of from about 1 to about 10,000 ppm, alternatively an amount of from about 10 to about 5,000 ppm in this component in terms of mass units with respect to the present composition. This is because when the amount of component (F) is greater than or equal to the lower limit of the aforementioned range, storage stability of the composition is good, whereas when the amount of component (F) is less than or equal to the upper limit of the aforementioned range, curability of the composition at low temperatures is good.

In order to improve adhesion of the cured product to a base material being contacted during curing, the present composition may contain (G) an adhesion promotor. In certain embodiments, the adhesion promotor for component (G) is typically an organosilicon compound having at least one alkoxy group bonded to a silicon atom in a molecule. This alkoxy group is exemplified by a methoxy group, an ethoxy group, a propoxy group, a butoxy group, and a methoxyethoxy group; and the methoxy group is most typical. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl) ethyl group, a 3-(3,4-epoxycyclohexyl) propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom. This organosilicon compound generally has a silicon-bonded alkenyl group or silicon-bonded hydrogen atom. Moreover, due to the ability to impart good adhesion with respect to various types of base materials, this organosilicon compound generally has at least one epoxy group-containing monovalent organic group in a molecule. This type of organosilicon compound is exemplified by organosilane compounds, organosiloxane oligomers and alkyl silicates. Molecular structure of the organosiloxane oligomer or alkyl silicate is exemplified by a linear chain structure, partially branched linear chain structure, branched chain structure, ring-shaped structure, and net-shaped structure. A linear chain structure, branched chain structure, and net-shaped structure are typical. This type of organosilicon compound is exemplified by silane compounds such as 3-glycidoxypropyltrimethoxysilane, 2-(3,4-epoxycyclohexyl) ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxyl group and at least one silicon-bonded alkenyl group in the molecule; and methyl polysilicate, ethyl polysilicate, and epoxy group-containing ethyl polysilicate.

In the present composition, an amount of component (G) is not particularly limited, but in order to achieve good adhesion to a base material being contacted during curing, it is typically at most 10 parts by mass relative to 100 parts by mass of the total mass of components (A) to (C).

A refractive index at 25° C. of the present composition is not limited, but it is typically in a range from 1.415 to 1.470. While, a viscosity at 25° C. of the present composition is not limited, but it is typically in a range from 10 to 200 Pas as measured at shear rate of 1/s. Thixotropic index of the present composition is not limited, but it is typically in a range of from 1.2 to 6.0, alternatively in a range of from 1.2 to 5.5, alternatively in a range of from 1.5 to 6.0, alternatively in a range of from 1.5 to 5.5, alternatively in a range of from 2.0 to 6.0, or alternatively in a range of from 2.0 to 5.5. This is because, if thixotropic index of the present composition is equal to or above the lower limit of the range described above, the present composition will be able to make its shape kept after dispensing it, whereas it is equal to or below the upper limit of the range described above, the present composition will be able to form an appropriate shape such as a convex lenticular shape and when dispensing it. “Thixotropic index” used herein is calculated from a ratio of viscosities at 25° C. of the present composition at share rate of 1/s and 10/s ([viscosity at 1/s]/[viscosity at 10/s]) measured by means of a Rheometer using a spindle.

### EXAMPLES

The curable silicone composition of the present invention will be described in detail hereinafter using Examples and Comparative Examples. However, the present invention is not limited by the description of the below listed Examples.

### Gel Permeation Chromatography (GPC)

GPC data for component (a1) and (a2) was collected using a Waters 2695 Separation Module from Waters Corporation with Waters 2414 Refractive index detector (RID). Three (7.8 by 300 mm) Styragel HR columns (with a molecular weight separation range of 100 to 4,000,000) and a Styragel protection column with toluene (4.6 by 30 mm) are used as the columns. The sample was prepared as a 0.5 wt % solution in toluene and filtered through a 0.45 micron PTFE syringe filter. Using a flow rate of one milliliter per minute, the temperature of the detector and the column are 45 degrees Celsius, the injection volume is 100 microliters, and the running time is 60 minutes. Number average molecular weights (Mn) was calculated relative to linear polystyrene standards covering the molecular weight range of 580 to 2,610,000.

### Refractive Index

A refractive index at 25° C. of the curable silicone composition was measured by means of an abbe refractometer produced by ATAGO Co., Ltd. at a wavelength of 589 nm under atmospheric pressure of 1013 mbar in accordance with the standard DIN 51423.

### Viscosity

A viscosity at 25° C. of each organosiloxane oligomers and organopolysiloxanes was measured by means of DV1 VISCOMETER (Brookfield) for 1 minute using the spindle #CP-40Z.

### Thixotropic Index

A viscosity at 25° C. of the curable silicone composition was measured by means of ARES G2 Rheometer (TA instrument) using the spindle (Part #543661.901, Stainless Steel, 25 mm, 2°, ETC Cone). The viscosities (Pas) at shear rate of 1/s and 10/s were measured for 1 min. Thixotropic index was calculated from a ratio of viscosities at shear rate of 1/s and 10/s=[viscosity@1/s] /[viscosity@10/s].

### Hardness

The curable silicone composition was poured into a mold having a depression of a predetermined shape (thickness=10 mm), and then was cured at 150°° C. for 1 hr. Hardness of a cured product was measured by means of a type D durometer hardness tester and a type A durometer hardness tester by means of a Shore A durometer specified by ASTM D2240.

### Transmittance

The curable silicone composition was poured into a mold (thickness=1 mm) and sandwiched between microslide glasses (Matsunami Glass Co., Ltd., Product #9213). The assembled sample was cured at 190° C. for 30 mins. Transmittance (%) at wavelength of 450 nm, 550nm, and 700 nm were measured by a method specified in ASTM D 1003 (UV-Visible

Spectrophotometer, Konica Minolta CM-3600A, Reference=water) at room temperature.

### Examples 1-8 and Comparative Examples 1-11

The following components were mixed to uniformity in the quantity proportions shown in Tables 1-4 to produce curable silicone compositions. When component (A) was a solid at 25° C., it was added to other components by using a solvent such as toluene and xylene due to high viscosity. Then, to prepare solventless composition, the solvent was evaporated and replace with other components to facilitate mixing. For example, firstly, component (B) was added to a solution of component (A) dissolved in a solvent. Then, the solvent was removed under reduced pressure by heating with nitrogen bubbling. After cooling to room temperature, component (C) was added. The mixture was mixed at room temperature. Additionally, other components were added to the mixture and mixed at room temperature. The resulting compositions and cured products were evaluated as mentioned above. These results are given in Tables 1-4. The “SiH/Vi ratio” in each of Tables 1-4 indicates a molar ratio of all silicon atom-bonded hydrogen atoms relative to all silicon atom-bonded vinyl groups in components (A) to (C).

The following organopolysiloxane resins were used as component (A).
(a1): an organopolysiloxane resin represented by the following average unit formula:

[(CH₃)₃SiO_{1/2}]_{0.40}[(CH₂═CH)(CH₃)₂SiO_{1/2}]_{0.04}(SiO_{4/2})_{0.56}
having a vinyl group content of about 1.9 mass % and a number average molecular weight (Mn) of about 5,000, and being a solid at 25° C.
(a2): an organopolysiloxane resin represented by the following average unit formula:

[(CH₃)₃SiO_{1/2}]_{0.40}[(CH₂═CH)(CH₃)₂SiO_{1/2}]_{0.10}(SiO_{4/2})_{0.50}
having a vinyl group content of about 3.0 mass % and a number average molecular weight (Mn) of about 3,000, and being a solid at 25° C.

The following organopolysiloxane resins were used as comparison of component (A).
(a3): an organopolysiloxane resin represented by the following average unit formula:

[(CH₂═CH)(CH₃)₂SiO_{1/2}]_{0.25} (C₆H₅SiO_{3/2})_{0.75}
having a vinyl group content of 5.62 mass %, and being a solid at 25° C.
(a4): an organopolysiloxane resin represented by the following average unit formula:

[(CH₃)₃SiO_{1/2}]_{0.14}[(CH₂═CH)(CH₃)₂SiO_{1/2}]_{0.11}(CH₃SiO_{3/2})_{0.53}(C₆H₅SiO_{3/2})_{0.22}
having a vinyl group content of about 2.2 mass %, and being a solid at 25° C.

The following organosiloxane oligomers were used as component (B).
(b1): an organosiloxane oligomer represented by the following formula:

(CH₂═CH)(CH₃)₂SiO(C₆H₅)₂SiOSi(CH₃)₂(CH═CH₂)
and having a viscosity of 8.7 mPa·s and a vinyl group content of about 14.06 mass %.
(b2): an organosiloxane oligomer represented by the following formula:

H(CH₃)₂SiO(C₆H₅)₂SiOSi(CH₃)₂H
and having a viscosity of 4.4 mPa·s and a silicon atom-bonded hydrogen atom content of about 0.61 mass %.
(b3): an organosiloxane oligomer represented by the following average unit formula:

[(CH₃)₂HSiO_{1/2}]_{0.60} (C₆H₅SiO_{3/2})_{0.40}
and having a viscosity of 29 mPa·s and a silicon atom-bonded hydrogen atom content of about 0.65 mass %.

The following organopolysiloxanes were used as comparison of component (B).
(b4): an organopolysiloxane represented by the following formula:

(CH₂═CH)(CH₃)₂SiO[(C₆H₅)(CH₃)SiO]₂₀Si(CH₃)₂(CH═CH₂)
and having a viscosity of 2,300 mPa·s and a vinyl group content of about 1.43 mass %.
(b5): an organopolysiloxane represented by the following formula:

(CH₂═CH)(CH₃)₂SiO[(CH₃)₂SiO]₂₀₀[(C₆H₅)₂SiO]₅₀Si(CH₃)₂(CH═CH₂)
and having a viscosity of 14,000 mPa·s and a vinyl group content of about 0.22 mass %.

The following organopolysiloxanes were used as component (C).
(c1): an organopolysiloxane represented by the following formula:

(CH₂═CH)(CH₃)₂SiO[(CH₃)₂SiO]₇Si(CH₃)₂(CH═CH₂)
and having a viscosity of 7 mPa·s and a vinyl group content of about 7.49 mass %.
(c2): an organopolysiloxane represented by the following formula:

(CH₂═CH)(CH₃)₂SiO[(CH₃)₂SiO]₄₅Si(CH₃)₂(CH═CH₂)
and having a viscosity of 60 mPa·s and a vinyl group content of about 1.66 mass %.
(c3): an organopolysiloxane represented by the following formula:

H(CH₃)₂SiO[(CH₃)₂SiO]₁₆Si(CH₃)₂H
and having a viscosity of 15 mPa·s and a silicon atom-bonded hydrogen atom content of about 0.15 mass %.
(c4): an organopolysiloxane resin represented by the following average unit formula:

[(CH₃)₂HSiO_{1/2}]_{0.65}(SiO_{4/2})_{0.35}
and having a viscosity of 23 mPa·s and a silicon atom-bonded hydrogen atom content of about 0.96 mass %.

The following fumed silica was used as component (D).
(d1): a fumed silica with a BET specific surface area of 230 m²/g (REOLOSIL DM-30S from TOKUYAMA Corporation)

The following a hydrosilylation reaction catalyst was used as component (E).
(e1): a platinum complex with 1,3-divinyl-1,1,3,3-tetramethyldisiloxane in a 1,3-divinyl-1,1,3,3-tetramethyldisiloxane solution (platinum content=4 mass %) The following hydrosilylation reaction inhibitors were used as component (F).
(f1): 1-ethynyl-cyclohexan-1-ol
(f2): 1,3,5,7-tetramethyl-1,3,5,7-tetravinylcyclotetrasiloxane

The following adhesion promotors were used as component (G).
(g1): 1,6-bis (trimethoxysilyl) hexane
(g2): an organopolysiloxane resin represented by the following average unit formula:

[(CH₂═CH)(CH₃)₂SiO_{1/2}]_{0.18} (C₆H₅SiO_{3/2})_{0.54}[CH₂(O)CHCH₂O(CH₂)₃SiO_{3/2}]_{0.2}

TABLE 1

| | | | Examples | | | | Comparative Example |
|---|---|---|---|---|---|---|---|
| | | | IE1 | IE2 | IE3 | IE4 | CE1 |
| Formulation | (A) | (a1) | 49.54 | 53.45 | 55.41 | 56.32 | 65.06 |
| of | | (a2) | 0 | 0 | 0 | 0 | 0 |
| curable | | (a3) | 0 | 0 | 0 | 0 | 0 |
| silicone | | (a4) | 0 | 0 | 0 | 0 | 0 |
| composition | (B) | (b1) | 4.97 | 14.90 | 19.86 | 8.02 | 16.04 |
| (parts | | (b2) | 21.23 | 22.91 | 23.75 | 14.21 | 8.02 |
| by | | (b3) | 0 | 0 | 0 | 0 | 0 |
| mass) | | (b4) | 0 | 0 | 0 | 0 | 0 |
| | | (b5) | 0 | 0 | 0 | 0 | 0 |
| | (C) | (c1) | 24.27 | 8.74 | 0.98 | 16.51 | 0.98 |
| | | (c2) | 0 | 0 | 0 | 0 | 0 |
| | | (c3) | 0 | 0 | 0 | 0 | 0 |
| | | (c4) | 0 | 0 | 0 | 4.95 | 9.90 |
| | (D) | (d1) | 8.91 | 8.91 | 8.91 | 8.91 | 8.91 |
| | (E) | (e1) | 0.011 | 0.011 | 0.011 | 0.011 | 0.011 |
| | (F) | (f1) | 0.010 | 0.010 | 0.010 | 0.010 | 0.010 |
| | | (f2) | 0 | 0 | 0 | 0 | 0 |
| | (G) | (g1) | 0 | 0 | 0 | 0 | 0 |
| | | (g2) | 0 | 0 | 0 | 0 | 0 |

| SiH/Vi ratio | | 1.0 | 1.0 | 1.0 | 1.1 | 1.1 |
|---|---|---|---|---|---|---|
| Refractive Index | | 1.442 | 1.455 | 1.462 | 1.440 | 1.444 |
| Shear rate (Pa · s) | @1/s | 61.22 | 81.26 | 114.1 | 101.8 | 625 |
| | @10/s | 14.59 | 21.35 | 31.15 | 28.4 | 450.7 |
| Thixotropic index | | 4.2 | 3.8 | 3.7 | 3.6 | 1.4 |
| Hardness | Shore A | 41 | 57 | 65 | 78 | — |
| | Shore D | 11 | 19 | 29 | 40 | — |
| Transmittance | 450 nm | 99.86 | 100.26 | 99.36 | 99.87 | — |
| (%) | 550 nm | 100.2 | 100.5 | 99.83 | 100.0 | — |
| | 700 nm | 100.5 | 100.8 | 100.3 | 100.5 | — |

TABLE 2

| | | | Examples | | | |
|---|---|---|---|---|---|---|
| | | | IE5 | IE6 | IE7 | IE8 |
| Formulation | (A) | (a1) | 0 | 0 | 0 | 0 |
| of | | (a2) | 56.33 | 58.55 | 60.62 | 53.77 |
| curable | | (a3) | 0 | 0 | 0 | 0 |
| silicone | | (a4) | 0 | 0 | 0 | 0 |
| composition | (B) | (b1) | 0 | 0 | 0 | 0 |
| (parts | | (b2) | 15.23 | 3.96 | 3.96 | 0 |
| by | | (b3) | 0 | 10.24 | 0 | 17.91 |
| mass) | | (b4) | 0 | 0 | 0 | 0 |
| | | (b5) | 0 | 0 | 0 | 0 |
| | (C) | (c1) | 0 | 0 | 0 | 0 |
| | | (c2) | 26.31 | 27.25 | 28.14 | 28.31 |
| | | (c3) | 0 | 0 | 0 | 0 |
| | | (c4) | 2.13 | 0 | 7.28 | 0 |
| | (D) | (d1) | 5.95 | 5.28 | 5.28 | 5.27 |
| | (E) | (e1) | 0.009 | 0.008 | 0.008 | 0.005 |
| | (F) | (f1) | 0.027 | 0.026 | 0.026 | 0.053 |
| | | (f2) | 0 | 0 | 0 | 0 |
| | (G) | (g1) | 0.266 | 0.264 | 0.264 | 0 |
| | | (g2) | 0 | 0 | 0 | 0 |

| SiH/Vi ratio | | 1.4 | 1.1 | 1.1 | 1.5 |
|---|---|---|---|---|---|
| Refractive Index | | 1.430 | 1.428 | 1.420 | 1.429 |
| Shear rate (Pa · s) | @1/s | 37.37 | 55.1 | 57.1 | 19.2 |
| | @10/s | 6.92 | 13.9 | 20.8 | 13.1 |
| Thixotropic index | | 5.4 | 4.0 | 2.7 | 1.5 |
| Hardness | Shore A | 51 | 91 | 95 | 90 |
| | Shore D | — | 42 | 48 | 44 |
| Transmittance (%) | 450 nm | 99.97 | 99.97 | 99.08 | 99.95 |
| | 550 nm | 100.2 | 100.2 | 99.36 | 100.1 |
| | 700 nm | 100.4 | 100.4 | 99.9 | 100.4 |

TABLE 3

| | | | Comparative Examples | | | |
|---|---|---|---|---|---|---|
| | | | CE2 | CE3 | CE4 | CE5 |
| Formulation | (A) | (a1) | 0 | 0 | 0 | 0 |
| of | | (a2) | 55.78 | 54.94 | 55.41 | 57.66 |
| curable | | (a3) | 0 | 0 | 0 | 0 |
| silicone | | (a4) | 0 | 0 | 0 | 0 |
| composition | (B) | (b1) | 0 | 0 | 0 | 0 |
| (parts | | (b2) | 15.08 | 0 | 0 | 0 |
| by | | (b3) | 0 | 0 | 0 | 0 |
| mass) | | (b4) | 0 | 0 | 0 | 15.56 |
| | | (b5) | 0 | 0 | 0 | 0 |
| | (C) | (c1) | 0 | 0 | 0 | 0 |
| | | (c2) | 27.03 | 26.82 | 26.92 | 26.88 |
| | | (c3) | 0 | 10.79 | 10.46 | 0 |
| | | (c4) | 2.11 | 7.45 | 7.21 | 10.00 |
| | (D) | (d1) | 0 | 8.64 | 5.23 | 6.00 |
| | (E) | (e1) | 0.010 | 0.011 | 0.010 | 0.009 |
| | (F) | (f1) | 0.030 | 0.054 | 0.052 | 0.027 |
| | | (f2) | 0 | 0 | 0 | 0 |
| | (G) | (g1) | 0 | 0 | 0 | 0 |
| | | (g2) | 0 | 0 | 0 | 0 |

| SiH/Vi ratio | | 1.4 | 1.1 | 1.1 | 1.1 |
|---|---|---|---|---|---|
| Refractive Index | | 1.429 | 1.415 | 1.414 | — |
| Shear rate (Pa · s) | @1/s | 0.57 | 233.4 | 40.30 | — |
| | @10/s | 0.57 | 44.82 | 10.83 | — |
| Thixotropic index | | 1.0 | 5.2 | 3.7 | — |
| Hardness | Shore A | 23 | 91 | 89 | — |
| | Shore D | — | 42 | 39 | — |
| Transmittance (%) | 450 nm | 100.6 | 96.39 | 96.86 | — |
| | 550 nm | 100.7 | 97.35 | 97.71 | — |
| | 700 nm | 100.7 | 95.78 | 96.03 | — |

TABLE 4

| | | | Comparative Examples | | | | | |
|---|---|---|---|---|---|---|---|---|
| | | | CE6 | CE7 | CE8 | CE9 | CE10 | CE11 |
| Formulation | (A) | (a1) | 0 | 0 | 0 | 0 | 0 | 0 |
| of | | (a2) | 0 | 0 | 0 | 0 | 0 | 0 |
| curable | | (a3) | 58.75 | 58.75 | 3.63 | 3.63 | 0 | 0 |
| silicone | | (a4) | 0 | 0 | 74.33 | 74.33 | 0 | 0 |
| composition | (B) | (b1) | 0 | 0 | 0 | 0 | 0 | 0 |
| (parts | | (b2) | 20.43 | 20.43 | 17.07 | 17.07 | 0 | 0 |
| by | | (b3) | 2.87 | 2.87 | 0.54 | 0.54 | 1.33 | 1.33 |
| mass) | | (b4) | 17.96 | 17.96 | 4.43 | 4.43 | 0 | 0 |
| | | (b5) | 0 | 0 | 0 | 0 | 98.67 | 98.67 |
| | (C) | (c1) | 0 | 0 | 0 | 0 | 0 | 0 |
| | | (c2) | 0 | 0 | 0 | 0 | 0 | 0 |
| | | (c3) | 0 | 0 | 0 | 0 | 0 | 0 |
| | | (c4) | 0 | 0 | 0 | 0 | 0 | 0 |
| | (D) | (d1) | 5.13 | 7.18 | 4.73 | 9.45 | 5.10 | 8.17 |
| | (E) | (e1) | 0.006 | 0.006 | 0.006 | 0.006 | 0.006 | 0.006 |
| | (F) | (f1) | 0.039 | 0.039 | 0.054 | 0.054 | 0.061 | 0.061 |
| | | (f2) | 0.205 | 0.205 | 1.738 | 1.738 | 0 | 0 |
| | (G) | (g1) | 0 | 0 | 0 | 0 | 0 | 0 |
| | | (g2) | 2.354 | 2.354 | 2.158 | 2.158 | 0 | 0 |

| SiH/Vi ratio | | 1.1 | 1.1 | 1.5 | 1.5 | 1.1 | 1.1 |
|---|---|---|---|---|---|---|---|
| Refractive Index | | 1.533 | 1.532 | 1.482 | 1.481 | 1.484 | 1.483 |
| Shear rate | @1/s | 105.5 | 572.0 | 17.95 | 142.1 | 47.69 | 139.7 |
| (Pa · s) | @10/s | 23.24 | 90.85 | 17.77 | 80.40 | 28.25 | 57.02 |
| Thixotropic index | | 4.54 | 6.30 | 1.01 | 1.77 | 1.69 | 2.45 |
| Hardness | Shore A | 85 | 89 | 90 | 95 | 17 | 19 |
| | Shore D | 50 | 53 | 56 | 58 | — | — |
| Transmittance | 450 nm | 77.30 | 70.86 | 96.52 | 95.09 | 98.52 | 97.64 |
| (%) | 550 nm | 85.18 | 80.84 | 98.45 | 98.10 | 99.66 | 99.36 |
| | 700 nm | 90.93 | 88.59 | 99.73 | 99.81 | 100.4 | 100.3 |

Examples IE1 to IE8 are representative examples of the curable silicone composition described herein which exhibits thixotropic property (thixotropic index ≥1.5) with transparency (Transmittance>99% at 450 nm). As shown in Comparative Example CE2, it is failed to achieve thixotropic property without component (D). Meanwhile, Comparative Examples CE3 and CE4 show inferior optical property, 96.39% and 96.86% at 450 nm, respectively. When Comparative Example CE4 and Examples IE5 to IE8 are compared, the use of component (B) is thought to impart transparency with exhibiting thixotropic property.

According to Comparative Example CE5, an inhomogeneous hazy liquid is obtained because comparative component (b4) is not compatible with component (A) and (C).

Comparative Examples CE6 to CE9 demonstrates curable silicone compositions using comparative component (a3, a4) and comparative component (b4, b5), which shows inferior optical transmittance less than 99% at 450 nm.

In case of Comparative Example CE1, too viscous liquid is obtained when 65.06 mass % of component (a1) is used.

### INDUSTRIAL APPLICABILITY

The curable silicone composition of the present invention has an excellent thixotropic property and can cure to form a transparent cured product despite containing a large quantity of an organopolysiloxane resin. Therefore, the curable silicone composition is useful for sealants, adhesives, or coatings of an optical semiconductor element in electric/electronic apparatus.

1. A curable silicone composition comprising:
(A) an organopolysiloxane resin represented by the following average unit formula:
(R¹₃SiO_{1/2})ₐ(R²R¹₂SiO_{1/2})_{b}(SiO_{4/2})_{c}(HO_{1/2})_{d}
wherein each R¹ is independently an alkyl group; R² is an alkenyl group; and “a”, “b”, “c” and “d” are numbers satisfying the following conditions: a>0, b>0, 0.3≤c≤0.7, 0≤d≤0.05, and a+b+c=1;
(B) an organosiloxane oligomer having a viscosity at 25° C. of not more than 1,000 mPa·s, and selected from (B₁) an organosiloxane oligomer having at least one silicon atom-bonded alkenyl group and at least one silicon atom-bonded aryl group in a molecule, (B₂) an organosiloxane oligomer having at least one silicon atom-bonded hydrogen atom and at least one silicon atom-bonded aryl group in a molecule, and a mixture of components (B₁) and (B₂);
(C) an organopolysiloxane selected from (C₁) an organopolysiloxane having at least one alkenyl group and not having a silicon atom-bonded aryl group and SiO_{4/2} unit in a molecule, (C₂) an organopolysiloxane having at least one silicon atom-bonded hydrogen atom and not having a silicon atom-bonded aryl group in a molecule, and a mixture of components (C₁) and (C₂);
(D) a silica filler; and
(E) a catalytic amount of a hydrosilylation reaction catalyst,
wherein an amount of component (A) is in a range of from 40.0 to 65.0 mass %, an amount of component (B) is in a range of from 1.0 to 55.0 mass %, and an amount of component (C) is in a range of from 0 to 50.0 mass %, each based on a total mass of components (A) to (C), and an amount of component (D) is in a range of from 1 to 10 parts by mass relative to 100 parts by mass of a total mass of components (A) to (C), with the proviso that a molar ratio of all silicon atom-bonded hydrogen atoms relative to all silicon atom-bonded alkenyl groups in components (A) to (C) is in a range of from 0.5 to 2.0.

2. The curable silicone composition according to claim 1, wherein component (B₁) is at least one selected from
(B₁₁) an organosiloxane oligomer represented by the following general formula:
R²R³₂SiO(R³₂SiO)ₘSiR³₂R²
wherein each R² is independently an alkenyl group; each R³ is independently an alkyl group or an aryl group, with the proviso that at least one R³ is an aryl group; and “m” is an integer of 0 to 10, and (B₁₂) an organosiloxane oligomer represented by the following average unit formula:
(R²R³₂SiO_{1/2})ₑ(R³SiO_{3/2})_{f}
wherein R² and R³ are as described above; and “e” and “f” are numbers satisfying the following conditions: e>0, f>0, and e+f=1.

3. The curable silicone composition according to claim 2, wherein component (B₁₁) is at least one selected from organosiloxane oligomers represented by the following formulae:
(CH₂═CH)(CH₃)₂SiO(C₆H₅)₂SiOSi(CH₃)₂(CH═CH₂)
(CH₂═CH)(CH₃)₂SiO(C₆H₅)(CH₃)SiOSi(CH₃)₂(CH═CH₂)
(CH₂═CH)(CH₃)(C₆H₅)SiOSi(CH₃)(C₆H₅)(CH═CH₂)
and
component (B₁₂) is an organosiloxane oligomer represented by the following general unit formula:
[(CH₂═CH)(CH₃)₂SiO_{1/2}]ₑ[(C₆H₅)SiO_{3/2}]_{f}
wherein “e” and “f” are as described above.

4. The curable silicone composition according to claim 1, wherein component (B₂) is at least one selected from
(B₂₁) an organosiloxane oligomer represented by the following general formula:
HR³₂SiO(R³₂SiO)ₘSiR³₂H
wherein each R³ is independently an alkyl group or an aryl group, with the proviso that at least one R³ is an aryl group; and “m” is an integer of 0 to 10, and (B₂₂) an organosiloxane oligomer represented by the following average unit formula:
(R³₂HSiO_{1/2})ₑ(R³SiO_{3/2})_{f}
wherein R³ is as described above; and “e” and “f” are numbers satisfying the following conditions: e>0, f>0, and e+f=1.

5. The curable silicone composition according to claim 4, wherein component (B₂₁) is at least one selected from organosiloxane oligomers represented by the following formulae:
H(CH₃)₂SiO(C₆H₅)₂SiOSi(CH₃)₂H
H(CH₃)₂SiO(C₆H₅) (CH₃)SiOSi(CH₃)₂H
and
component (B₂₂) is an organosiloxane oligomer represented by the following general unit formula:
[(CH₃)₂HSiO_{1/2}]ₑ[(C₆H₅)SiO_{3/2}]_{f}
wherein “e” and “f” are as described above.

6. The curable silicone composition according to claim 1, further comprising:
(F) a hydrosilylation reaction inhibitor, in an amount of 0.1 to 10,000 ppm in this component in terms of mass units with respect to the composition.

7. The curable silicone composition according to claim 6, further comprising:
(G) an adhesion promotor, in an amount of at most 10 parts by mass relative to 100 parts by mass of a total mass of components (A) to (C).

8. A cured product obtained by curing the curable silicone composition according to claim 1.

9. The curable silicone composition according to claim 2, wherein component (B₂) is at least one selected from
(B₂₁) an organosiloxane oligomer represented by the following general formula:
HR³₂SiO(R³₂SiO)ₘSiR³₂H
wherein each R³ is independently an alkyl group or an aryl group, with the proviso that at least one R³ is an aryl group; and “m” is an integer of 0 to 10, and (B₂₂) an organosiloxane oligomer represented by the following average unit formula:
(R³₂HSiO_{1/2})ₑ(R³SiO_{3/2})
wherein R³ is as described above; and “e” and “f” are numbers satisfying the following conditions: e>0, f>0, and e+f=1.

10. The curable silicone composition according to claim 9 wherein component (B₂₁) is at least one selected from organosiloxane oligomers represented by the following formulae:
H(CH₃)₂SiO(C₆H₅)₂SiOSi(CH₃)₂H
H(CH₃)₂SiO(C₆H₅)(CH₃)SiOSi(CH₃)₂H
and
component (B₂₂) is an organosiloxane oligomer represented by the following general unit formula:
[(CH₃)₂HSiO_{1/2}]ₑ[(C₆H₅)SiO_{3/2}]_{f}
wherein “e” and “f” are as described above.

11. The curable silicone composition according to claim 1, further comprising:
(G) an adhesion promotor, in an amount of at most 10 parts by mass relative to 100 parts by mass of a total mass of components (A) to (C).
